(19) United States
(12) Patent Application Publication
(10) Pub. No.: US 2023/0112637 A1
(43) Pub. Date: Apr. 13, 2023

(54) FAST-CHARGING GRAPHITE AND BATTERY

(71) Applicant: JIANGSU ZENERGY BATTERY TECHNOLOGIES CO., LTD., Suzhou (CN)

(72) Inventors: Hao ZHANG, Dongguan (CN); Chuanjian ZHANG, Dongguan (CN); Jiao LIU, Dongguan (CN); Wen TANG, Dongguan (CN); Kecheng JIANG, Dongguan (CN); Yi YAO, Dongguan (CN)

(21) Appl. No.: 18/064,670

(22) Filed: Dec. 12, 2022

Related U.S. Application Data
(63) Continuation of application No. PCT/CN2021/092566, filed on May 10, 2021.

(30) Foreign Application Priority Data
Sep. 21, 2020 (CN) 202010992949.X

(51) Int. Cl. H01M 4/587; H01M 4/38; H01M 4/66

(52) U.S. Cl. CPC H01M 4/587; H01M 4/386; H01M 4/661; H01M 4/667; H01M 2004/027

(57) ABSTRACT

Disclosed are a fast-charging graphite and a battery. The graphite has a graphitization degree of 90-97% and a lithium-ion diffusion coefficient of 2.3×10⁻¹⁴−8.7×10⁻¹² cm²/s at 25° C. and a state of charge (SOC) of 10%. The battery includes a cathode plate, an anode plate, a separator arranged between the cathode plate and the anode plate, and an electrolyte. The anode plate includes an anode current collector and an anode coating coated on at least one side of the anode current collector. The anode coating includes an anode active material, and the anode active material includes the fast-charging graphite.

### CROSS-REFERENCE TO RELATED APPLICATIONS

This application is a continuation of International Patent Application No. PCT/CN2021/092566, filed on May 10, 2021, which claims the benefit of priority from Chinese Patent Application No. 202010992949.X, filed on Sep. 21, 2020. The content of the aforementioned application, including any intervening amendments thereto, is incorporated herein by reference in its entirety.

### TECHNICAL FIELD

This application relates to lithium-ion batteries, and more particularly to a fast-charging graphite and a battery.

### BACKGROUND

With the continuous upgrading of material development and cell manufacturing, the energy density of power batteries has increased significantly, with the range increasing from 150 km to 400 km for mainstream mass-produced passenger cars, which can meet the range requirements of consumers. However, the charging rate of the power battery still remains to be enhanced.

During the fast-charging process, lithium ions need to be embedded in the layered graphite anode quickly. If the graphite has poor kinetics, the lithium ions cannot be fully embedded in the graphite bulk phase to form LiₓC compound, and will precipitate on the surface of the pole piece to form lithium dendrites, thus affecting the cycle stability and safety of the cell. Therefore, the solid phase diffusion of lithium ions in graphite materials is considered the determining step in the overall electrode reaction, and directly affects the charging rate of the battery. Consequently, in order to accelerate the charging of electric vehicles, it is required to develop high-performance fast-charging graphite materials to improve the diffusion kinetics of the graphite cathodes.

At present, the researches on fast-charging graphite mainly focus on surface coating and orientation index (OI). For example, Chinese Patent Publication No. 106981632A discloses a method for improving the charging capacity of anode materials, in which petroleum coke or asphalt coke with smaller particle size is crushed to shorten the lithium-ion migration path; high-temperature graphitization treatment is conducted to improve the discharge capacity and efficiency of the anode material; and carbon coating and granulation are performed to overcome graphite anisotropy caused by the high-temperature graphitization treatment. Chinese Patent Publication No. 108832075A selects a graphite anode with fast charging capability by studying the OI values of the cathode and anode pieces.

However, it has been rarely investigated about properties associated with graphite diffusion kinetics, such as graphitization degree (g) and lithium-ion diffusion coefficient (D). The graphitization degree refers to the proportion of the carbonaceous material that reaches the complete graphite crystal structure, and the higher the graphitization degree, the closer the carbonaceous material is to the complete graphite crystal, which is not conductive to the rapid intercalation and de-intercalation of lithium ions. Moreover, the diffusion of lithium ions in the active electrode material is a limiting factor for the electrochemical reactions in the lithium-ion battery. Therefore, the lithium-ion diffusion coefficient is considered important for the optimization of the charge rate of the lithium-ion battery.

Given this, it is necessary to develop a fast-charging graphite based on researches about physical properties of materials to meet the performance requirements of advanced lithium-ion batteries.

### SUMMARY

A first objective of this application is to provide a graphite material having a great fast-charging performance.

A second objective of this application is to provide a battery with the graphite as an anode active material, which exhibits excellent kinetic performance, charging capability and cycle performance.

The technical solutions of the disclosure are described below.

In a first aspect, the disclosure provides a fast-charging graphite, wherein a graphitization degree of the fast-charging graphite is 90-97%; and a lithium-ion diffusion coefficient of the fast-charging graphite at 25° C. and a state of charge (SOC) of 10% is 2.3×10⁻¹⁴−8.7×10⁻¹² cm²/s.

In an embodiment, the graphitization degree of the fast-charging graphite is 92%-94%.

In an embodiment, the lithium-ion diffusion coefficient of the fast-charging graphite at 25° C. and a SOC of 10% is 7.6×10⁻¹³−6×10⁻¹² cm²/s.

In an embodiment, a particle size D₅₀ of the fast-charging graphite is 1-20 μm.

In an embodiment, the fast-charging graphite is selected from the group consisting of an artificial graphite, a natural graphite, a modified graphite, and a combination thereof.

In a second aspect, the present disclosure battery, comprising:

a cathode plate;

an anode plate;

a separator arranged between the cathode plate and the anode plate; and

an electrolyte;

wherein the anode plate comprises an anode current collector and an anode coating coated on at least one side of the anode current collector; the anode coating comprises an anode active material; and the anode active material comprises the aforementioned graphite.

In an embodiment, the anode active material further comprises at least one of a hard carbon, a soft carbon, a silicon-carbon composite, and a silicon-oxygen composite.

In an embodiment, the cathode plate comprises a cathode current collector and a cathode coating coated on at least one side of the cathode current collector; the cathode coating comprises a cathode active material; and the cathode active material comprises at least one of LiFePO₄ and LiₐNiₓCo_{y}M_{1-x-y}O₂, wherein 0.95≤a≤1.2; 0<x<1; 0<y<1; 0<x+y<1; and M is aluminum and/or manganese.

In an embodiment, the anode current collector is selected from the group consisting of a copper foil, carbon paper, a copper-coated polymer film and a combination thereof.

In an embodiment, the cathode current collector is selected from the group consisting of an aluminum foil, a nickel foil, an aluminum-coated polymer film and a combination thereof an aluminum foil, a nickel foil, and an aluminum-coated polymer film.

This application at least has the following beneficial effects compared with the prior art.

(1) By reasonably designing the graphitization degree and the lithium-ion diffusion coefficient, the graphite provided herein has a desired interlayer spacing, which can facilitate the rapid intercalation and de-intercalation of lithium ions, allowing for excellent fast-charging capability and high capacity and stability.

(2) This application also provides a battery with the fast-charging graphite provided herein as an anode active material, which exhibits excellent kinetic performance, charging performance and cycle stability.

### DETAILED DESCRIPTION OF EMBODIMENTS

The present application will be described in detail below.

1. Fast-Charging Graphite

This application provides a graphite, with a graphitization degree g of 90-97% and a lithium-ion diffusion coefficient D of 2.3×10⁻¹⁴−8.7×10⁻¹² cm²/s at 25° C. and a state of charge (SOC) of 10%.

The graphitization degree can be measured by X-Ray Diffraction (XRD). Specifically, the interplanar spacing in the XRD pattern of the crystal plane of the graphite (002) is obtained through calibration based on the position of the diffraction peak of the crystal plane of the Si standard sample (111), and plugged into the following formula to calculate the graphitization degree:

$$g = \frac{0.344 - d ( 002 )}{0.0086} ; where d ( 002 ) = \frac{λ}{2 sin \{ \frac{2 {θ}_{c} - [ ( 2 {θ}_{Si} ) - 28.466 ]}{2} \}} ;$$

the interplanar spacing of the graphite (002) is calibrated by using the Si sample; θ_{c} represents a diffraction angle of the crystal plane of the graphite (002); θ_{Si} represents a diffraction angle of the crystal plane of the Si sample (111); and λ is the average wavelength of coppers Kα₁ and Kα₂, and λ=0.15418 nm.

The lithium-ion diffusion coefficient D can be obtained by the galvanostatic intermittent titration technique (GITT). Specifically, graphite is made into a pole plate to be subjected to the GITT test in a button cell. The button cell is allowed to stand for 10 h, titrated at a constant current of 0.1 C for 10 min, and subjected to another standing for 10 h to allow the current to be stable. The lithium-ion diffusion coefficient D, at 25° C. and SOC of 10%, is calculated by the following formula:

$$D = \frac{4}{πτ} \times {( \frac{{mV}_{m}}{MA} )}^{2} \times {( \frac{Δ {E}_{s}}{Δ {E}_{τ}} )}^{2} ;$$

where D represents the diffusion coefficient; τ is the pulse time; m, Vₘ, and M are the weight, molar volume, and molar weight of the active material, respectively; A is the area of the electrode material; and ΔEₛ and ΔE_{τ} are the voltage changes during the chilling and pulse phases, respectively.

The graphitization degree g of the fast-charging graphite provided herein is preferably 92-94%. If the graphitization degree is too low, the interlayer spacing of the fast-charging graphite is large, resulting in a loose structure, a low capacity, and a poor cycling stability. If the graphitization degree is too high, the interlayer spacing of the fast-charging graphite is small, which is not conducive to the rapid intercalation and de-intercalation of lithium ions.

The fast-charging graphite provided herein has a particle size D₅₀ of 1-20 μm.

The fast-charging graphite provided herein is selected from the group consisting of an artificial graphite, a natural graphite, a modified graphite, and a combination thereof.

This application also provides a battery, which includes a cathode plate, an anode plate, a separator arranged between the cathode plate and the anode plate, and an electrolyte. The anode plate includes an anode current collector and an anode coating coated on at least one side of the anode current collector. The anode coating layer includes an anode active material. The anode active material includes the aforementioned fast-charging graphite.

In an embodiment, the anode active material further includes at least one of hard carbon, soft carbon, a silicon-carbon composite, and a silicon-oxygen composite.

In an embodiment, the cathode plate includes a cathode current collector and a cathode coating layer coated on at least one side of the cathode current collector. The cathode coating layer includes a cathode active material. The cathode active material includes at least one of LiFePO₄ and LiₐNiₓCo_{y}M_{1-x-y}O₂, where 0.95≤a≤1.2; 0<x<1; 0<y<1; 0<x+y<1; and M is aluminum and/or manganese.

In an embodiment, the anode current collector is selecting from the group consisting of a copper foil, carbon paper, a copper-coated polymer film, and a combination thereof, preferably, copper foil.

In an embodiment, the cathode current collector is selecting from the group consisting of an aluminum foil, a nickel foil, and an aluminum-coated polymer, preferably, aluminum foil.

In an embodiment, both anode coating and cathode coating further includes a binder and a conductive agent, the type and proportion of which are determined according to actual requirements.

In an embodiment, the specific type and composition of the electrolyte and the separator are not specifically limited and can be selected according to the actual requirements.

The present disclosure will be further described below with reference to the following embodiments. It should be understood that these embodiments are only illustrative of the present disclosure and not intended to limit the scope of the present disclosure.

### EXAMPLE 1

### Preparation of an Anode Plate

A fast-charging graphite, an aqueous dispersion of acrylonitrile multi-copolymer binder (LA133), sodium carboxymethyl cellulose (CMC) and Super P conductive carbon black (SP) were mixed in a weight ratio of 96.2:1.5:1.5:0.8, and dispersed in water to produce an anode slurry. The anode slurry was then coated on a copper foil, dried and cold pressed to a compacted density of 1.65 g/cc. The graphite had a graphitization degree g of 92.3% and a lithium-ion diffusion coefficient D of 6×10⁻¹² cm²/s at 25° C. and 10% SOC.

### Preparation of a Cathode Plate

Nickel cobalt manganese oxide (NCM523, as the cathode active material), a polyvinylidene fluoride (PVDF) binder, Super P conductive carbon black (SP), and carbon nanotubes (CNT) were mixed in a weight ratio of 97.8:0.9:0.8:0.5, and dispersed in N-methylpyrrolidone (NMP) to prepare a cathode slurry. The cathode slurry was then coated on an aluminum foil, dried and cold pressed to a compacted density of 3.4 g/cc.

The anode plate, the cathode plate and a polyethylene separator arranged therebetween were assembled into a cell, which was injected with an electrolyte, and subjected to formation and capacity grading to obtain a battery.

### EXAMPLE 2

This example was different from Example 1 merely in the fast-charging graphite. In this example, the fast-charging graphite had a graphitization degree g of 93.1% and a lithium-ion diffusion coefficient D of 4.6×10⁻¹² cm²/s at 25° C. and 10% SOC.

### EXAMPLE 3

This example was different from Example 1 merely in the fast-charging graphite. In this example, the fast-charging graphite had a graphitization degree g of 94.2% and a lithium-ion diffusion coefficient D of 8.6×10⁻¹³ cm²/s at 25° C. and 10% SOC.

### EXAMPLE 4

This example was different from Example 1 merely in the fast-charging graphite. In this example, the fast-charging graphite had a graphitization degree g of 90.5% and a lithium-ion diffusion coefficient D of 8.3×10⁻¹³ cm²/s at 25° C. and 10% SOC.

### EXAMPLE 5

This example was different from Example 1 merely in the fast-charging graphite. In this example, the fast-charging graphite had a graphitization degree g of 96% and a lithium-ion diffusion coefficient D of 6.1×10⁻¹⁴ cm²/s at 25° C. and 10% SOC.

### EXAMPLE 6

This example was different from Example 1 merely in the composition of the anode slurry. In this example, the anode slurry further included hard carbon.

### EXAMPLE 7

This example was different from Example 1 merely in the composition of the anode slurry. In this example, the anode slurry further included a silicon-carbon composite.

### EXAMPLE 8

This example was different from Example 1 merely in the composition of the anode slurry. In this example, the anode slurry further included a silicon-oxygen composite.

### COMPARATIVE EXAMPLE 1

This example was different from Example 1 merely in the fast-charging graphite. In this example, the fast-charging graphite had a graphitization degree g of 98.7% and a lithium-ion diffusion coefficient D of 6.1×10⁻¹⁴ cm²/s at 25° C. and 10% SOC.

### COMPARATIVE EXAMPLE 2

This example was different from Example 1 merely in the fast-charging graphite. In this example, the fast-charging graphite had a graphitization degree g of 96.6% and a lithium-ion diffusion coefficient D of 9.6×10⁻¹² cm²/s at 25° C. and 10% SOC.

### COMPARATIVE EXAMPLE 3

This example was different from Example 1 merely in the fast-charging graphite. In this example, the fast-charging graphite had a graphitization degree g of 88% and a lithium-ion diffusion coefficient D of 1.2×10⁻¹⁴ cm²/s at 25° C. and 10% SOC.

### COMPARATIVE EXAMPLE 4

This example was different from Example 1 merely in the graphitization degree of the fast-charging graphite, which was 88% in this example.

### COMPARATIVE EXAMPLE 5

This example was different from Example 1 merely in the graphitization degree of the fast-charging graphite, which was 98% in this example.

### COMPARATIVE EXAMPLE 6

This example was different from Example 1 merely in the lithium-ion diffusion coefficient D of the fast-charging graphite at 25° C. and 10% SOC, which was 2.2×10⁻¹⁴ cm²/s in this example.

### COMPARATIVE EXAMPLE 7

This example was different from Example 1 merely in the lithium-ion diffusion coefficient D of the fast-charging graphite at 25° C. and 10% SOC, which was 8.8×10⁻¹² cm²/s in this example.

### Performance Test

Electrochemical tests were performed on lithium-ion batteries obtained in Examples 1-8 and the Comparative Examples 1-7.

(1) Charging Performance Test

At 25° C., a battery sample was charged to 100% SOC at 5C current and then discharged to 0% SOC at 1C current. After ten charge-discharge cycles, the battery sample was then charged to 100% SOC at 5C current, and disassembled to observe the state of the anode plate, so as to determine the kinetic performance of the battery based on the lithium precipitation area. A larger lithium precipitation area indicated poor kinetics characteristic and charging capability, and a smaller lithium precipitation area indicated better kinetics characteristic and charging capability.

(2) Cycle Stability Test

The battery sample was charged to 100% SOC at 3C current and discharged to 0% SOC at 1C current, and cycled until its capacity decayed to 80% of the initial capacity. The number of cycles was recorded, and the larger the number of cycles, the better the cycle stability.

TABLE 1
Test results of lithium-ion batteries obtained in Examples 1-8 and the Comparative Examples 1-7

| | | Graphitization | Diffusion | Lithium | The |
|---|---|---|---|---|---|
| | | degree | coefficient | precipitation | number |
| Batteries | Anode active material | (%) | (cm²/s) | area (%) | of cycles |
| Example 1 | Fast-charging graphite 1 | 92.3 | 6 × 10⁻¹² | 2 | 1880 |
| Example 2 | Fast-charging graphite 2 | 93.1 | 4.6 × 10⁻¹² | 2.8 | 1670 |
| Example 3 | Fast-charging graphite 3 | 94.2 | 8.6 × 10⁻¹³ | 3 | 1550 |
| Example 4 | Fast-charging graphite 4 | 90.5 | 8.3 × 10⁻¹³ | 4 | 1490 |
| Example 5 | Fast-charging graphite 5 | 96 | 6.1 × 10⁻¹⁴ | 6 | 1430 |
| Example 6 | Fast-charging graphite 1/ | 92.3 | 6 × 10⁻¹² | 2.2 | 1810 |
| | hard carbon | | | | |
| Example 7 | Fast-charging graphite 1/ | 92.3 | 6 × 10⁻¹² | 2.1 | 1830 |
| | silicon-carbon composite | | | | |
| Example 8 | Fast-charging graphite 1/ | 92.3 | 6 × 10⁻¹² | 2.3 | 1790 |
| | silicon-oxygen composite | | | | |
| Comparative Example 1 | Comparative graphite 1 | 98.7 | 6.1 × 10⁻¹⁴ | 8 | 1250 |
| Comparative Example 2 | Comparative graphite 2 | 96.6 | 9.6 × 10⁻¹² | 8 | 1200 |
| Comparative Example 3 | Comparative graphite 3 | 88 | 1.2 × 10⁻¹⁴ | 11 | 830 |
| Comparative Example 4 | Comparative graphite 4 | 88 | 6 × 10⁻¹² | 6.8 | 910 |
| Comparative Example 5 | Comparative graphite 5 | 98 | 6 × 10⁻¹² | 8.5 | 1380 |
| Comparative Example 6 | Comparative graphite 6 | 92.3 | 2.2 × 10⁻¹⁴ | 9.2 | 1350 |
| Comparative Example 7 | Comparative graphite 7 | 92.3 | 8.8 × 10⁻¹² | 7.1 | 1140 |

It could be seen from Table 1 that the battery with the fast-charging graphite provided herein as the anode active material had a small lithium-precipitation area and slow capacity decay, indicating that the battery made with the fast-charging graphite provided herein had better kinetics, good charging capacity, and better cycling stability. Either the graphitization degree or the diffusion coefficient was too high or too low, the graphite had poor performance. In other words, only when both the graphitization degree and the diffusion coefficient of the fast-charging graphite were controlled within the limitations of this application, the battery could show good kinetics, charging capacity, and cycling stability. In particular, when the fast-charging graphite had a graphitization degree of 92.3% and a diffusion coefficient of 6×10⁻¹² cm²/s, the fabricated battery had the smallest lithium-precipitated area and the largest cycle number, namely, the best kinetic performance, charging capacity, and cycling stability. The reasons were described below. (1) When the graphitization degree was too low, the layer spacing of the graphite was large, resulting in a loose structure, a low capacity, and a poor cycling stability. When the graphitization degree was too high, the layer spacing of the graphite was small, which was not conducive to the rapid intercalation and de-intercalation of lithium ions. (2) When the diffusion coefficient was too low, the lithium-ion diffusion rate of the graphite was affected, while when the diffusion coefficient was too high, the layer spacing of the graphite was large, resulting in a lower capacity. Therefore, this application controlled both the graphitization degree and diffusion coefficient of the fast-charging graphite within a reasonable range to ensure that the graphite had good fast-charging performance, while the lithium-ion battery made with this graphite had both excellent cycle life and kinetic performance.

Though the embodiments have been described in detail above, changes and modifications can still be made thereto by those skilled in the art. The above-mentioned embodiments are merely illustrative and not intended to limit the disclosure. It should be understood that those modifications, replacements, and variations made by those skilled in the art based on the content disclosed herein without paying creative effort shall fall within the scope of the present disclosure defined by the appended claims. Furthermore, specific terms used herein are merely for the convenience of description and are not intended to limit the present disclosure.

What is claimed is:

1. A fast-charging graphite, wherein a graphitization degree of the fast-charging graphite is 90-97%; and a lithium-ion diffusion coefficient of the fast-charging graphite at 25° C. and a state of charge (SOC) of 10% is 2.3×10⁻¹⁴−8.7×10⁻¹² cm²/s.

2. The fast-charging graphite of claim 1, wherein the graphitization degree of the fast-charging graphite is 92%-94%.

3. The fast-charging graphite of claim 1, wherein the lithium-ion diffusion coefficient of the fast-charging graphite at 25° C. and a SOC of 10% is 7.6×10⁻¹³−6×10⁻¹² cm²/s.

4. The fast-charging graphite of claim 1, wherein a particle size D₅₀ of the fast-charging graphite is 1-20 μm.

5. The fast-charging graphite of claim 1, wherein the fast-charging graphite is selected from the group consisting of an artificial graphite, a natural graphite, a modified graphite, and a combination thereof.

6. A battery, comprising:
a cathode plate;
an anode plate;
a separator arranged between the cathode plate and the anode plate; and
an electrolyte;
wherein the anode plate comprises an anode current collector and an anode coating coated on at least one side of the anode current collector; the anode coating comprises an anode active material; and the anode active material comprises the fast-charging graphite of claim 1.

7. The battery of claim 6, wherein the anode active material further comprises at least one of hard carbon, soft carbon, a silicon-carbon composite, and a silicon-oxygen composite.

8. The battery of claim 6, wherein the cathode plate comprises a cathode current collector and a cathode coating coated on at least one side of the cathode current collector; the cathode coating comprises a cathode active material; and the cathode active material comprises at least one of LiFePO₄ and LiₐNiₓCo_{y}M_{1-x-y}O₂, wherein 0.95≤a≤1.2; 0<x<1; 0<y<1; 0<x+y<1; and M is aluminum and/or manganese.

9. The battery of claim 6, wherein the anode current collector is selected from the group consisting of a copper foil, carbon paper, a copper-coated polymer film and a combination thereof.

10. The battery of claim 8, wherein the cathode current collector is selected from the group consisting of an aluminum foil, a nickel foil, an aluminum-coated polymer film and a combination thereof.
